(19) United States
(12) Patent Application Publication
(10) Pub. No.: US 2022/0025211 A1
(43) Pub. Date: Jan. 27, 2022

(54) URETHANE RESIN COMPOSITION, SURFACE TREATMENT AGENT, AND ARTICLE

(71) Applicant: DIC Corporation, Tokyo (JP)

(72) Inventors: Morio Satou, Komaki-shi (JP); Miyo Sakai, Komaki-shi (JP); Takanori Nakasyouya, Komaki-shi (JP); Hiroyuki Chijiwa, Takaishi-shi (JP)

(73) Assignee: DIC Corporation, Tokyo (JP)

(21) Appl. No.: 17/311,753

(22) PCT Filed: Dec. 5, 2019
(86) PCT No.: PCT/JP2019/047587

§ 371 Date: Jun. 8, 2021

(30) Foreign Application Priority Data
Dec. 21, 2018 (JP) 2018-239602

(51) Int. Cl. C09D 175/04; C08L 75/04; C09D 7/63

(52) U.S. Cl. CPC C09D 175/04; C09D 7/63; C08L 75/04

(57) ABSTRACT

The present invention provides a urethane resin composition including a urethane resin (A), an olefin resin (B), water (C), and a carbodiimide compound (D) having a carbodiimide equivalent of 340 or more. Also, the present invention provides a surface treatment agent including the urethane resin composition described above. Further, present invention provides an article including a layer formed of the surface treatment agent. The content of urethane bond in the urethane resin (A) is preferably within a range of 980 to 4,000 mmol/kg. The content of urea bond in the urethane resin (A) is preferably within a range of 315 to 850 mmol/kg.

### TECHNICAL FIELD

The present invention relates to a urethane resin composition, a surface treatment agent, and an article having a layer formed of the surface treatment agent.

### BACKGROUND ART

In a process of producing a sheet for automotive interior leather, the surface thereof is finished with a surface treatment agent from the viewpoint of imparting chemical resistance and design. The mainstream of materials having been used for usual surface treatment agents is a solvent-based resin composition containing an organic solvent, but development of an aqueous surface treatment agent containing substantially no organic solvent has been advanced in response to the recent increase in environmental regulations.

For example, a method of overcoating two types of urethane resin compositions containing water is disclosed as the aqueous surface treatment agent (refer to, for example, Patent Literature 1). This method exhibits excellent adhesion to a substrate and excellent abrasion resistance, but ethanol resistance is unsatisfactory.

Thus, it is indicated that a surface treatment agent made aqueous has poor chemical resistance, particularly poor ethanol resistance, as compared with a usual solvent-based resin composition.

### CITATION LIST

### Patent Literature

PTL 1: Japanese Unexamined Patent Application Publication No. 2006-176615

### SUMMARY OF INVENTION

### Technical Problem

A problem to be solved by the present invention is to provide a urethane resin composition containing water and having excellent ethanol resistance.

### Solution to Problem

The present invention provides a urethane resin composition including a urethane resin (A), an olefin resin (B), water (C), and a carbodiimide compound (D) having a carbodiimide equivalent of 340 or more.

Also, the present invention provides a surface treatment agent including the urethane resin composition described above, and also provides an article including a layer formed of the surface treatment agent.

### Advantageous Effects of Invention

A urethane resin composition according to the present invention has excellent ethanol resistance. Also, the urethane resin composition of the present invention contains water and is an environmentally friendly material.

### Description of Embodiments

A urethane resin composition according to the present invention includes a urethane resin (A), an olefin resin (B), water (C), and a specific carbodiimide compound (D).

The urethane resin (A) can be dispersed in the water (C), and usable examples thereof include a urethane resin having a hydrophilic group such as an anionic group, a cationic group, a nonionic group, or the like; a urethane resin forcibly dispersed in water (B) by using an emulsifier; and the like. These urethane resins (A) may be used alone or in combination of two or more.

A method for producing the urethane resin having an anionic group is, for example, a method using, as a raw material, one or more compounds selected from the group consisting of a compound having a carboxyl group and a compound having a sulfonyl group.

Usable examples of the compound having a carboxyl group include 2,2-dimethylol propionic acid, 2,2-dimethylol butanoic acid, 2,2-dimethylol butyric acid, 2,2-dimethylol propionic acid, 2,2-valeric acid, and the like. The compounds may be used alone or in combination of two or more.

Usable examples of the compound having a sulfonyl group include 3,4-diaminobutane sulfonic acid, 3,6-diamino-2-toluene sulfonic acid, 2,6-diaminobenzne sulfonic acid, N-(2-aminoethyl)-2-aminoethyl sulfonic acid, and the like. These compounds may be used alone or in combination of two or more.

The carboxyl group and the sulfonyl group may be partially or entirely neutralized to a basic compound in the resin composition. Usable examples of the basic compound include organic amines such as ammonia, triethylamine, pyridine, morpholine, and the like; alkanolamines such as monoethanolamine, dimethylethanolamine, and the like; metal basic compounds containing a sodium, potassium, lithium, calcium, or the like; and the like.

A method for producing the urethane resin having a cationic group is, for example, a method using as a raw material one or two or more of compounds having an amino group.

Usable examples of the compound having an amino group include compounds having a primary or secondary amino group, such as triethylene tetramine, diethylene triamine, and the like; compounds having a tertiary amino group, such as N-alkyldialkanolamines such as N-methyldiethanolamine, N-ethyldiethanolamine, and the like, N-alkyldiaminoalkylamines such as N-methyldiaminoethylamine, N-ethyldiaminoethylamine, and the like; and the like. These compounds may be used alone or in combination of two or more.

A method for producing the urethane resin having a nonionic group is, for example, a method using as a raw material one or two or more of compounds having an oxyethylene structure.

Usable examples of the compounds having an oxyethylene structure include polyether polyols having an oxyethylene structure, such as polyoxyethylene glycol, polyoxyethylene polyoxypropylene glycol, polyoxyethylene polyoxytetramethylene glycol, and the like. These compounds may be used alone or in combination of two or more.

From the viewpoint of obtaining more excellent chemical resistance, abrasion resistance, weather resistance, and hydrolysis resistance, the amount of the raw material used for producing the urethane resin having a hydrophilic group is preferably within a range of 0.1% to 15% by mass, more preferably within a range of 1% to 10% by mass, and still more preferably within a range of 1.5% to 7% by mass in the raw material of the urethane resin (A).

Usable examples of the emulsifier used for producing the urethane resin forcibly dispersed in the water (C) include nonionic emulsifiers such as polyoxyethylene nonylphenyl ether, polyoxyethylene lauryl ether, polyoxyethylene styrylphenyl ether, polyoxyethylene sorbitol tetraoleate, polyoxyethylene-polyoxypropylene copolymer, and the like; anionic emulsifiers such as fatty acid salts, such as sodium oleate and the like, alkylsulfate ester salts, alkylbenzene sulfonate salts, alkylsulfosuccinate salts, naphthalene sulfonate salt, polyoxyethylene alkylsulfate salts, alkanesulfonate sodium salts, sodium alkyl diphenyl ether sulfonate salt, and the like; cationic emulsifiers such as alkylamine salts, alkyltrimethyl ammonium salts, alkyldimethylbenzyl ammonium salts, and the like; and the like. These emulsifiers may be used alone or in combinate of two or more.

Specifically, for example, the reaction product of the raw material used for producing the urethane resin having a hydrophilic group, polyisocyanate (a1), polyol (a2), and a chain extender (a3) can be used as the urethane resin (A). Known urethanization reaction can be used as the reaction.

Usable example so the polyisocyanate (a1) include aromatic polyisocyanates such as phenylene diisocyanate, tolylene diisocyanate, diphenylmethane diisocyanate, xylylene diisocyanate, naphthalene diisocyanate, polymethylene polyphenyl polyisocyanate, carbodiimidized diphenylmethane polyisocyanate, and the like; aliphatic or alicyclic polyisocyanates such as hexamethylene diisocyanate, lysine diisocyanate, cyclohexane diisocyanate, isophorone diisocyanate, dicyclohexylmethane diisocyanate, xylylene diisocyanate, tetramethylxylylene diisocyanate, dimer acid diisocyanate, norbornene diisocyanate, and the like; and the like. These polyisocyanates may be used alone or in combination of two or more.

From the viewpoint of obtaining more excellent chemical resistance, abrasion resistance, and weather resistance, an alicyclic polyisocyanate is preferably used as the polyisocyanate (a1), a polyisocyanate having one or more structures in which a nitrogen atom of at least an isocyanate group is directly linked to a cyclohexane ring is more preferably used, and isophorone diisocyanate and/or dicyclohexylmethane diisocyanate is still more preferably used. In addition, from the viewpoint of obtaining more excellent chemical resistance, abrasion resistance, and weather resistance, the amount of the alicyclic polyisocyanate used is preferably 30% by mass or more, more preferably 40% by mass or more, and still more preferably 50% by mass or more in the polyisocyanate (a1).

Also, when the urethane resin composition of the present invention is used as a surface treatment agent and when more light resistance is required, the alicyclic polyisocyanate is preferably used in combination with the aliphatic polyisocyanate as the polyisocyanate (a1), and hexamethylene diisocyanate is preferably used as the aliphatic polyisocyanate. In this case, the amount of the alicyclic polyisocyanate used is preferably 30% by mass or more, more preferably 40% by mass or more, and still more preferably 50% by mass or more in the polyisocyanate (a1).

From the viewpoint of obtaining more excellent chemical resistance, abrasion resistance, and weather resistance, the amount of the polyisocyanate (a1) used is preferably within a range of 5% to 50% by mass, more preferably within a range of 15% to 40% by mass, and still more preferably within a range of 20% to 37% by mass in the raw materials of the urethane resin (A).

Usable examples of the polyol (a2) include polyetherpolyol, polyesterpolyol, polyacrylpolyol, polycarbonatepolyol, polybutadienepolyol, and the like. These polyols may be used alone or in combination of two or more. Among these, polycarbonatepolyol is preferably used from the viewpoint of obtaining more excellent chemical resistance, abrasion resistance, and weather resistance.

For example, the reaction product of carbonate ester and/or phosgene and a compound having two or more hydroxyl groups can be used as the polycarbonatepolyol.

Usable examples of the carbonate ester include dimethyl carbonate, diethyl carbonate, diphenyl carbonate, ethylene carbonate, propylene carbonate, and the like. These compounds may be sed alone or in combination of two or more.

Usable examples of the compound having two or more hydroxyl groups include ethylene glycol, propylene glycol, 1,3-propanediol, 1,4-butanedio1, 1,3-butanediol, 1,2-butanediol, 2-methyl-1,3-propanediol, 1,5-pentanediol, neopentyl glycol, 1,6-hexanediol, 1,5-hexanediol, 3-methyl-1,5-pentanediol, 1,7-pentanediol, 1,8-octanediol, 1,9-nonanediol, 1,8-nonanediol, 2-ethyl-2-butyl-1,3-propanediol, 1,10-decanediol, 1,12-dodecanediol, 1,4-cyclohexanesdimethanol, 1,3-cyclohexanedimethanol, trimethylolpropane, 3-methylpentanediol, neopentyl glycol, trimethylolethane, glycerin, and the like. These compounds may be used alone or in combination of two or more. Among these, from the viewpoint of obtaining more excellent chemical resistance, abrasion resistance, and weather resistance, one or more compounds selected from the group consisting of 1,3-propanediol, 1,4-butanediol, 1,5-pentanediol, 1,6-hexanediol, 1,4-cyclohexanedimethanol, 3-methylpentanediol, and 1,10-decanediol are preferably used, and 1,6-hexanediol is more preferred.

From the viewpoint of obtaining more excellent chemical resistance, abrasion resistance, and weather resistance, the amount of the polycarbonatepolyol used is preferably 85% by mass or more, more preferably 90% by mass or more, and still more preferably 95% by mass or more in the polyol (a2).

From the viewpoint of obtaining more excellent chemical resistance, mechanical strength, abrasion resistance, and weather resistance, the number-average molecular weight of the polycarbonatepolyol is preferably within a range of 100 to 100,000, more preferably within a range of 150 to 10,000, and still more preferably within a range of 200 to 2,500. The number-average molecular weight of the polycarbonatepolyol represents a value measured by gel permeation column chromatography (GPC).

From the viewpoint of obtaining more excellent weather resistance, the number-average molecular weight of the polyol (a2) other than the polycarbonatepolyol is preferably within a range of 500 to 100,000, more preferably within a range of 700 to 50,000, and still more preferably within a range of 800 to 10,000. The number-average molecular weight of the polyol (a2) represents a value measured by gel permeation column chromatography (GPC).

The amount of the polyol (a2) used is preferably within a range of 30% to 80% by mass, more preferably within a range of 40% to 75% by mass, and still more preferably within a range of 50% to 70% by mass or more in the raw materials of the urethane resin (A).

The chain extender (a3) is, for example, one (excluding the polycarbonatepolyol) having a number-average molecular weight within a range of 50 to 450, and examples thereof include chain extenders having an amino group, such as ethylenediamine, 1,2-propanediamine, 1,6-hexamethylenediamine, piperazine, 2,5-dimethylpiperazine, isophoronediamine, 1,2-cyclohexanediamine, 1,3-cyclohexanediamine, 1,4-cyclohexanediamine, 4,4′-dicyclohexylmethanediamine, 3,3′-dimethyl-4,4′-dicyclohexylmethanediamine, 1,4-cyclohexanediamine, hydrazine, and the like; chain extenders having a hydroxyl group, such as ethylene glycol, diethylene glycol, triethylene glycol, propylene glycol, dipropylene glycol, 1,3-propanediol, 1,3-butanediol, 1,4-butanediol, hexamethylene glycol, sucrose, methylene glycol, glycerin, sorbitol, bisphenol A, 4,4′-dihydroxydiphenyl, 4,4′-dihydroxydiphenyl ether, trimethylolpropane, and the like. These chain extenders may be used alone or in combination of two or more.

From the viewpoint of obtaining more excellent chemical resistance, mechanical strength, abrasion resistance, and weather resistance, among these, the extenders having an amino group are preferably used as the chain extender (a3), and piperazine and/or hydrazine are more preferred. The total amount of piperazine and hydrazine in the chain extender (a3) is preferably 30% by mass or more, more preferably 50% by mass or more, still more preferably 60% by mass or more, and particularly preferably 80% by mass or more. The average number of functional groups in the chain extender (a3) is preferably less than 3 and more preferably less than 2.5.

From the viewpoint of obtaining more excellent chemical resistance, mechanical strength, abrasion resistance, and weather resistance, the amount of the chain extender (a3) used is preferably within a range of 0.5% to 10% by mass, more preferably within a range of 0.7% to 5% by mass, and still more preferably within a range of 0.9% to 2.3% by mass in the raw materials of the urethane resin (A).

Examples of a method for producing the urethane resin (A) include a production method including reacting the polyisocyanate (a1), the polyol (a2), and the raw material used for producing the urethane resin having a hydrophilic group to produce a urethane prepolymer having an isocyanate group, and then reacting the urethane prepolymer with the chain extender (a3); a method of charging and reacting together the polyisocyanate (a1), the polyol (a2), the raw materials used for producing the urethane resin having a hydrophilic group, and the chain extender (a3); and the like. These reactions are performed, for example, at 50° C. to 100° C. for 3 to 10 hours.

The molar ratio [(isocyanate group)/(hydroxyl group and amino group)] of isocyanate groups possessed by the polyisocyanate (a1) to the total of hydroxyl groups possessed by the raw materials used for producing the urethane resin having a hydrophilic group, hydroxyl groups possessed by the polyol (a2) and hydroxyl group and amino group possessed by the chain extender (a3) is preferably within a range of 0.8 to 1.2 and more preferably within a range of 0.9 to 1.1.

In producing the urethane resin (A), the isocyanate group remaining in the urethane resin (A) is preferably deactivated. When the isocyanate group is deactivated, an alcohol having one hydroxyl group, such as methanol or the like, is preferably used. The amount of the alcohol used is preferably within a range of 0.001 to 10 parts by mass relative to 100 parts by mass of the urethane resin (A).

In producing the urethane resin (A), an organic solvent may be used. Usable examples of the organic solvent include ketone compounds such as acetone, methyl ethyl ketone, and the like; ether compounds such as tetrahydrofuran, dioxane, and the like; acetate ester compounds such as ethyl acetate, butyl acetate, and the like; nitrile compounds such as acetonitrile and the like; amide compounds such as dimethylformamide, N-methylpyrrolidone, and the like; and the like. These organic solvents may be used alone or in combination of two or more. The organic solvent is preferably finally removed by a distillation method or the like.

From the viewpoint of obtaining more excellent chemical resistance, abrasion resistance, and weather resistance, the content of urethane bond in the urethane resin (A) is preferably within a range of 930 to 4,000 mmol/kg, more preferably within a range of 1,000 to 3,500 mmol/kg, still more preferably within a range of 1,100 to 3,000 mmol/kg, and even still more preferably within a range of 1,150 to 2,500 mmol/kg. The content of urethane bond in the urethane resin (A) represents a value calculated from the charged amounts of the polyisocyanate (a1), the polyol (a2), the raw materials used for producing the urethane resin having a hydrophilic group, and the chain extender (a3).

From the viewpoint of obtaining more excellent chemical resistance, abrasion resistance, and weather resistance, the content of urea bond in the urethane resin (A) is preferably within a range of 315 to 850 mmol/kg, more preferably within a range of 350 to 830 mmol/kg, still more preferably within a range of 400 to 800 mmol/kg, and even still more preferably within a range of 410 to 770 mmol/kg. The content of urea bond in the urethane resin (A) represents a value calculated from the charged amounts of the polyisocyanate (a1), the polyol (a2), the raw materials used for producing the urethane resin having a hydrophilic group, and the chain extender (a3).

From the viewpoint of obtaining more excellent chemical resistance, abrasion resistance, and weather resistance, the content of alicyclic structure in the urethane resin (A) is preferably within a range of 500 to 3,000 mmol/kg, more preferably within a range of 600 to 2,900 mmol/kg, and still more preferably within a range of 700 to 2,700 mmol/kg. The content of alicyclic structure in the urethane resin (A) represents a value calculated from the charged amounts of the polyisocyanate (a1), the polyol (a2), the raw materials used for producing the urethane resin having a hydrophilic group, and the chain extender (a3).

In view of coating properties, workability, and storage stability, the content of the urethane resin (A) is preferably within a range of 3% to 50% by mass and more preferably within a range of 5% to 30% by mass in the urethane resin composition.

The olefin resin (B) is used for the purpose of improving adhesion to a substrate. Usable examples of the olefin resin (B) include a polyolefin produced by polymerizing a polyolefin compound; natural rubber; ethylene-vinyl acetate copolymer; synthetic isopropylene rubber; and modified products thereof; and the like. These olefin resins may be used alone or in combination of two or more.

Usable examples of the polyolefin compound include ethylene, propylene, 1-butene, 1-pentene, 1-hexene, 1-heptene, 1-octene, 1-nonene, and the like. These olefin compounds may be used alone or in combination of two or more. The polyolefin may be either a homopolymer or a copolymer.

Usable examples of the modified products of the polyolefin include a hydroxyl group-modified polyolefin, an acid-modified polyolefin, an amino group-modified polyolefin, and the like. These polyolefins may be used alone or in combination of two or more. Among these, the acid-modified polyolefin is preferably used in view of more improving the substrate adhesion (particularly, to a thermoplastic olefin resin (TPO) leather).

For example, an acid-modified polyolefin without being chlorinated can be used as the acid-modified polyolefin. An acid modification method preferably includes reacting the polyolefin with unsaturated carboxylic acid or anhydride thereof. Usable examples of the unsaturated carboxylic acid include acrylic acid, methacrylic acid, maleic acid, fumaric acid, citraconic acid, mesaconic acid, itaconic acid, aconitic acid, and crotonic acid; anhydrides thereof; half-esters and half-amides of unsaturated carboxylic acids; and the like. These compounds may be used alone or in combination of two or more. Among these, one or more selected from the group consisting of acrylic acid, methacrylic acid, maleic acid, and maleic anhydride are preferably used.

In view of excellent dispersibility in water, the acid-modified polyolefin having a polyether chain is preferably used, and the polyether chain is preferably a polyethylene chain and/or a polypropylene chain, and the polyethylene chain is more preferred.

In view of obtaining more excellent substrate adhesion (particular, a TPO leather), the weight-average molecular weight of the olefin resin (B) is preferably within a range of 10,000 to 500,000, and more preferably within a range of 20,000 to 200,000. The weight-average molecular weight of the olefin resin (B) indicates a value measured by a gel permeation column chromatography (GPC) method.

In view of obtaining more excellent substrate adhesion (particular, a TPO leather), the content of the olefin resin (B) is preferably within a range of 0.01% to 10% by mass and more preferably within a range of 0.1% to 7% by mass.

In addition, the amount of the olefin resin (B) used relative to 100 parts by mass (=solid content) of the urethane resin (A) is preferably within a range of 1 to 60 parts by mass and more preferably within a range of 2 to 50 parts by mass.

Ion exchange water, distilled water, or the like can be used as the water (C). In view of coating properties, workability, and storage stability of the urethane resin composition, the content of the water (C) is preferably within a range of 30% to 95% by mass and more preferably within a range of 50% to 90% by mass in the urethane resin composition.

In order to obtain excellent ethanol resistance, it is essential to use the carbodiimide compound (D) having a carbodiimide equivalent of 340 or more. In view of obtaining more excellent ethanol resistance, the carbodiimide equivalent of the carbodiimide compound (D) is preferably within a range of 360 to 1,000. This represents the chemical formula weight per mole of the carbodiimide group.

Usable examples of the carbodiimide compound (D) include carbodiimide compounds such as N,N′-dicyclohexylcarbodiimide, N,N′-diisopropylcarbodiimide, 1-ethyl-3-(3-dimethylaminopropyl)carbodiimide, N-[3-(dimethylamino)propyl]-N′-ethylcarbodiimide, N-[3-(dimethylamino)propyl]-N′-ethylcarbodiimide methiodide, N-tert-butyl-N′-ethylcarbodiimide, N-cyclohexyl-N′-(2-morpholinoethyl)carbodiimide meso-p-toluenesulfonate, N,N′-di-tert-butylcarbodiimide, N,N′-di-p-tolylcarbodiimide, and the like; a carbodiimide compound produced by known condensation reaction of polyisocyanate in the presence of a carbodiimidation catalysts; a carbodiimide compound produced using polyisocyanate and polyalkylene oxide as raw materials; and the like. These carbodiimide compounds may be used alone or in combination of two or more.

Examples of available commercial products of the preferred carbodiimide compound (D) include “Carbodilite V-02”, “Carbodilite V-02-L2”, “Carbodilite SV-02”, “Carbodilite V-10”, “Carbodilite SW-12G”, “Carbodilite E-02”, “Carbodilite E-03A”, “Carbodilite E-05”, and the like, which are manufactured by Nisshinbo Chemical Inc.

In view of obtaining more excellent ethanol resistance, the content of the carbodiimide compound (D) is preferably within a range of 0.01% to 20% by mass, more preferably within a range of 0.1% to 10% by mass, and still more preferably within a range of 0.2% to 5% by mass.

In addition, the amount of the carbodiimide compound (D) used relative to 100 parts by mass (=solid content) of the urethane resin (A) is preferably within a range of 1 to 40 parts by mass and more preferably within a range of 2 to 35 parts by mass.

The urethane resin composition of the present invention contains the urethane resin (A), the olefin resin (B), the water (C), and the carbodiimide compound (D) as essential components and, if required, may further use other additives.

Usable examples of the additives include a filler (E), an emulsifier, a defoaming agent, a leveling agent, a thickening agent, a viscoelasticity modifier, a defoaming agent, a wetting agent, a dispersant, an antiseptic agent, a plasticizer, a penetrant, a fragrance, a germicide, a miticide, a fungicide, an ultraviolet absorber, an antioxidant, an antistatic agent, a flame retardant, a dye, a pigment (for example, titanium white, bengala, phthalocyanine, carbon black, permanent yellow, or the like), and the like. These additives may be used alone or in combination of two or more.

When the urethane resin composition of the present invention is used as the surface treatment agent and when used for a case requiring a matte feeling for a coating film, the filler (E) is preferably contained as the other additive.

Usable examples of the filler (E) include silica particles, organic beads calcium carbonate, magnesium carbonate, barium carbonate, talc, aluminum hydroxide, calcium sulfate, kaolin, mica, asbestos, mica, calcium silicate, alumina silicate, and the like. These fillers may be used alone or in combination of two or more.

Usable examples of the silica particles include dry silica, wet silica, and the like. Among these, because the range of adjustment of gloss value is widened due to a high scatting effect, the dry silica is preferred. The average particle diameter of the silica particles is preferably within a range of 2 to 14 μm and more preferably within a range of 3 to 12 μm. The average particle diameter of the silica particles represents a particle diameter (particle diameter at D50 in the particle size distribution) at accumulation volume of 50% in an accumulated particle volume curve resulting from particle size distribution measurement.

Usable examples of the organic beads include acrylic beads, urethane beads, silicone beads, olefin beads, and the like.

When the filler (E) is used, the amount of use can be properly determined according to the matte feeling imparted, but is preferably within a range of 0.1 to 30 parts by mass and more preferably within a range of 1 to 10 parts by mass relative to 100 parts by mass of the urethane resin (A).

Thus, the urethane resin composition of the present invention can cause excellent ethanol resistance. Therefore, the urethane resin composition of the present invention can be preferably used as a surface treatment agent for various articles such as a synthetic leather, a polyvinyl chloride (PVC) leather, a thermoplastic olefin (TPO) leather, a dashboard, an instrument panel, and the like, and can be particularly preferably used for a TPO leather.

An article of the present invention includes a layer formed of the surface treatment agent.

Examples of the article include an automotive interior sheet using a synthetic leather, an artificial leather, a natural leather, or a polyvinyl chloride (PVC) leather, a sport shoes, clothing, furniture, a thermoplastic olefin (TPO) leather, a dashboard, an instrument panel, and the like.

The thickness of the layer formed of the surface treatment agent is, for example, within a range of 0.1 to 100 μm.

### EXAMPLES

The present invention is described in further detail below by using examples.

### [Synthesis Example 1] Preparation of Urethane Resin (A-1) Water Dispersion

In a four-neck flask provided with a stirrer, a thermometer, and a nitrogen reflux tube, 250 parts by mass of methyl ethyl ketone and 0.001 parts by mass of stannous octylate were placed, and then 200 parts by mass of polycarbonatepolyol-1 (using 1,4-butanediol and 1,6-hexanediol as raw materials, number-average molecular weight: 1,000), 15 parts by mass of 2,2-dimethylolpropionic acid, 49 parts by mass of isophorone diisocyanate, and 34 parts by mass of hexamethylene diisocyanate were placed and reacted at 70° C. for 1 hour, preparing a methyl ethyl ketones solution of urethane prepolymer.

Next, 6.8 parts by mass of hydrazine and 15 parts by mass of triethylamine were mixed with the resultant methyl ethyl ketone solution of urethane prepolymer, and then 820 parts by mass of ion exchange water was added to prepare an emulsion in which a urethane resin (A-1) was dispersed in water.

Next, methyl ethyl ketone was distilled off from the resultant emulsion, and ion exchange water was further added, preparing a water dispersion of the urethane resin (A-1) with a nonvolatile content of 30% by mass.

The content of urethane bond in the resultant urethane resin (A-1) was 2,052 mmol/kg, the content of urea bond was 698 mmol/kg, and the content of an alicyclic structure was 715 mmol/kg.

### [Synthesis Example 2] Preparation of Urethane Resin (A-2) Water Dispersion

In a four-neck flask provided with a stirrer, a thermometer, and a nitrogen reflux tube, 250 parts by mass of methyl ethyl ketone and 0.001 parts by mass of stannous octylate were placed, and then 220 parts by mass of polycarbonatepolyol-3 (using 1,6-hexanediol as a raw material, number-average molecular weight: 2,000), 12 parts by mass of 2,2-dimethylolpropionic acid, and 70 parts by mass of dicyclohexylmethane diisocyanate were placed and reacted at 70° C. for 1 hour, preparing a methyl ethyl ketones solution of urethane prepolymer.

Next, 4.5 parts by mass of piperazine and 9 parts by mass of triethylamine were mixed with the resultant methyl ethyl ketone solution of urethane prepolymer, and then 880 parts by mass of ion exchange water was added to the resultant mixture, preparing an emulsion in which a urethane resin (A-2) was dispersed in water.

Next, methyl ethyl ketone was distilled off from the resultant emulsion, and ion exchange was further added, preparing a water dispersion of the urethane resin (A-2) with a nonvolatile content of 32% by mass.

The content of urethane bond in the resultant urethane resin (A-2) was 1,278 mmol/kg, the content of urea bond was 435 mmol/kg, and the content of an alicyclic structure was 1,713 mmol/kg.

### [Synthesis Example 3] Preparation of Urethane Resin (A-3) Water Dispersion

In a four-neck flask provided with a stirrer, a thermometer, and a nitrogen reflux tube, 250 parts by mass of methyl ethyl ketone and 0.001 parts by mass of stannous octylate were placed, and then 138 parts by mass of polycarbonatepolyol-4 (using 1,6-hexanediol as a raw material, number-average molecular weight: 2,000), 55 parts by mass of polycarbonatepolyol-5 (using 1,6-hexanediol as a raw material, number-average molecular weight: 500), 13 parts by mass of 2,2-dimethylolpropionic acid, and 100 parts by mass of dicyclohexylmethane diisocyanate were placed and reacted at 70° C. for 1 hour, preparing a methyl ethyl ketones solution of urethane prepolymer.

Next, 5.6 parts by mass of piperazine and 10 parts by mass of triethylamine were mixed with the resultant methyl ethyl ketone solution of urethane prepolymer, and then 880 parts by mass of ion exchange water was added to prepare an emulsion in which a urethane resin (A-3) was dispersed in water.

Next, methyl ethyl ketone was distilled off from the resultant emulsion, and ion exchange was further added, preparing a water dispersion of the urethane resin (A-3) with a nonvolatile content of 30% by mass.

The content of urethane bond in the resultant urethane resin (A-3) was 1,747 mmol/kg, the content of urea bond was 576 mmol/kg, and the content of an alicyclic structure was 2,341 mmol/kg.

### Example 1

A urethane resin composition was produced by mixing 40 parts by mass of the water dispersion of the urethane resin (A-1) prepared in Synthesis Example 1, 7 parts by mass of acid-modified unchlorinated polyolefin (“Arrowbase SD-1010” manufactured by Unitika Ltd., nonvolatile content: 20.5% by mass, abbreviated as “POf” hereinafter), 53 parts by mass of water, and 2.5 parts by mass of a carbodiimide compound (“Carbodilite V-02” manufactured by Nisshinbo Chemical Inc., carbodiimide equivalent: 590, nonvolatile content: 40% by mass, abbreviated as “NCN(1)” hereinafter).

### Example 2

A urethane resin composition was produced by mixing 42 parts by mass of the water dispersion of the urethane resin (A-1) prepared in Synthesis Example 1, 6 parts by mass of POf, 3 parts by mass of a filler (“ACEMATT TS 100” manufactured by Evonik Degussa Corporation, silica particles produced by a dry method, average particle diameter: 10 μm, abbreviated as “silica” hereinafter), 49 parts by mass of water, and 3.5 parts by mass of NCN(1).

### Example 3

A urethane resin composition was produced by the same method as in Example 1 except that the type of the carbodiimide compound was changed to “Carbodilite V-02-L2” manufactured by Nisshinbo Chemical Inc., carbodiimide equivalent: 385, nonvolatile content: 40% by mass, abbreviated as “NCN(2)” hereinafter).

### Example 4

A urethane resin composition was produced by the same method as in Example 2 except that the type of the carbodiimide compound was changed to NCN(2).

### Example 5

A urethane resin composition was produced by the same method as in Example 1 except that the type of the carbodiimide compound was changed to “Carbodilite SV-02” manufactured by Nisshinbo Chemical Inc., carbodiimide equivalent: 430, nonvolatile content: 40% by mass, abbreviated as “NCN(3)” hereinafter).

### Example 6

A urethane resin composition was produced by the same method as in Example 2 except that the type of the carbodiimide compound was changed to NCN(3).

### Example 7

A urethane resin composition was produced by the same method as in Example 1 except that the type of the carbodiimide compound was changed to “Carbodilite V-10” manufactured by Nisshinbo Chemical Inc., carbodiimide equivalent: 410, nonvolatile content: 40% by mass, abbreviated as “NCN(4)” hereinafter).

### Example 8

A urethane resin composition was produced by the same method as in Example 2 except that the type of the carbodiimide compound was changed to NCN(4).

### Example 9

A urethane resin composition was produced by the same method as in Example 1 except that the type of the carbodiimide compound was changed to “Carbodilite SW-12G” manufactured by Nisshinbo Chemical Inc., carbodiimide equivalent: 465, nonvolatile content: 40% by mass, abbreviated as “NCN(5)” hereinafter).

### Example 10

A urethane resin composition was produced by the same method as in Example 2 except that the type of the carbodiimide compound was changed to NCN(5).

### Example 11

A urethane resin composition was produced by the same method as in Example 1 except that the urethane resin (A-1) water dispersion was changed to the urethane resin (A-2) water dispersion prepared in Synthesis Example 2.

### Example 12

A urethane resin composition was produced by the same method as in Example 1 except that the urethane resin (A-1) water dispersion was changed to the urethane resin (A-3) water dispersion prepared in Synthesis Example 3.

### Comparative Example 1

A urethane resin composition was produced by the same method as in Example 1 except that the type of the carbodiimide compound was changed to “V-04” manufactured by Nisshinbo Chemical Inc. (carbodiimide equivalent: 335, abbreviated as “NCN-R(1)” hereinafter).

### Comparative Example 2

A urethane resin composition was produced by the same method as in Example 2 except that the type of the carbodiimide compound was changed to NCN-R(1).

### [Method for Measuring Number-Average Molecular Weight]

The number-average molecular weight of the polyol and the weight-average molecular weight of the olefin resin used in the synthesis examples represent values obtained by measurement by a gel permeation column chromatography (GPC) method under the following conditions.

Measurement apparatus: high-performance GPC apparatus (“HLC-8220GPC” manufactured by Tosoh Corporation)

Column: the following columns manufactured by Tosoh Corporation were connected in series and used.

“TSKgel G5000” (7.8 mm I. D.×30 cm)×1

“TSKgel G4000” (7.8 mm I. D.×30 cm)×1

“TSKgel G3000” (7.8 mm I. D.×30 cm)×1

“TSKgel G2000” (7.8 mm I. D.×30 cm)×1

Detector: RI (differential refractometer)

Column temperature: 40° C.

Eluent: tetrahydrofuran (THF)

Flow rate: 1.0 mL/min

Injection amount: 100 μL (tetrahydrofuran solution with a sample concentration of 0.4% by mass)

Standard sample: The following standard polystyrene was used for forming a calibration curve.

### (Standard Polystyrene)

“TSKgel standard polystyrene A-500” manufactured by Tosoh Corporation

“TSKgel standard polystyrene A-1000” manufactured by Tosoh Corporation

“TSKgel standard polystyrene A-2500” manufactured by Tosoh Corporation

“TSKgel standard polystyrene A-5000” manufactured by Tosoh Corporation

“TSKgel standard polystyrene F-1” manufactured by Tosoh Corporation

“TSKgel standard polystyrene F-2” manufactured by Tosoh Corporation

“TSKgel standard polystyrene F-4” manufactured by Tosoh Corporation

“TSKgel standard polystyrene F-10” manufactured by Tosoh Corporation

“TSKgel standard polystyrene F-20” manufactured by Tosoh Corporation

“TSKgel standard polystyrene F-40” manufactured by Tosoh Corporation

“TSKgel standard polystyrene F-80” manufactured by Tosoh Corporation

“TSKgel standard polystyrene F-128” manufactured by Tosoh Corporation

“TSKgel standard polystyrene F-288” manufactured by Tosoh Corporation

“TSKgel standard polystyrene F-550” manufactured by Tosoh Corporation

### [Method for Evaluating Ethanol Resistance]

The urethane resin composition produced in each of the examples and the comparative examples was prepared, coated by using a bar coater on a TPO sheet (thickness: 0.4 mm), which was surface-treated with corona by using bar coater No. 14, and then dried for 1 minute at 120° C., producing a sample for evaluation.

The coated film surface on the surface of the resultant sample for evaluation was rubbed with a cotton cloth dipped in a 30 mass % aqueous ethanol solution under a load of 500 g by using a Gakushin rubbing tester (“RT-200” manufactured by Daiei Kagaku Seiki Mfg. Co., Ltd.). The state of the coated film was observed and evaluated as follows.

“T”: No peeling of the coated film was observed even after 100 times of rubbing.

“F”: Peeling of the coated film was observed after less than 100 times of rubbing.

TABLE 1

| | | Example | Example | Example | Example |
|---|---|---|---|---|---|
| Table 1 | | 1 | 2 | 3 | 4 |
| Urethane resin (A) | | (A-1) | (A-1) | (A-1) | (A-1) |
| Olefin resin (B) | | POf | POf | POf | POf |
| Carbodiimide | Type | NCN(1) | NCN(1) | NCN(2) | NCN(2) |
| compound (D) | Carbodiimide | 590 | 590 | 385 | 385 |
| | equivalent | | | | |

| | | | | |
|---|---|---|---|---|
| Evaluation of ethanol resistance | T | T | T | T |

TABLE 2

| | | Example | Example | Example | Example |
|---|---|---|---|---|---|
| Table 2 | | 5 | 6 | 7 | 8 |
| Urethane resin (A) | | (A-1) | (A-1) | (A-1) | (A-1) |
| Olefin resin (B) | | POf | POf | POf | POf |
| Carbodiimide | Type | NCN(3) | NCN(3) | NCN(4) | NCN(4) |
| compound (D) | Carbodiimide | 430 | 430 | 410 | 410 |
| | equivalent | | | | |

| | | | | |
|---|---|---|---|---|
| Evaluation of ethanol resistance | T | T | T | T |

TABLE 3

| | | Example | Example | Example |
|---|---|---|---|---|
| Table 3 | | 9 | 10 | 11 |
| Urethane resin (A) | | (A-1) | (A-1) | (A-2) |
| Olefin resin (B) | | POf | POf | POf |
| Trisiloxane | Type | NCN(5) | NCN(5) | NCN(1) |
| compound (D) | Carbodiimide | 465 | 465 | 590 |
| | equivalent | | | |

| | | | |
|---|---|---|---|
| Evaluation of ethanol resistance | T | T | T |

TABLE 4

| | | Example | Comparative | Comparative |
|---|---|---|---|---|
| Table 4 | | 12 | Example 1 | Example 2 |
| Urethane resin (A) | | (A-3) | (A-1) | (A-1) |
| Olefin resin (B) | | POf | POf | POf |
| Trisiloxane | Type | NCN(1) | NCN-R(1) | NCN-R(1) |
| compound (D) | Carbodiimide | 590 | 335 | 335 |
| | equivalent | | | |

| | | | |
|---|---|---|---|
| Evaluation of ethanol resistance | T | F | F |

It was found that the urethane resin composition of the present invention has excellent ethanol resistance.

On the other hand, Comparative Examples 1 and 2 have a condition using the carbodiimide compound having a carbodiimide equivalent lower than the range specified in the present invention, and any one of the comparative examples has poor ethanol resistance.

1. A urethane resin composition comprising a urethane resin (A). an olefin resin (B), water (C), and a carbodiimide compound (D) having a carbodiimide equivalent of 340 or more.

2. The urethane resin composition according to claim 1, wherein the content of the carbodiimide compound (D) is within a range of 0.01% to 20% by mass.

3. A surface treatment agent comprising the urethane resin composition according to claim 1.

4. An article comprising a layer formed of the surface treatment agent according to claim 3.
